(19) United States
(12) Patent Application Publication
(10) Pub. No.: US 2014/0312691 A1
(43) Pub. Date: Oct. 23, 2014

(54) SMART POWER STRIP WITH AUTOMATIC DEVICE CONNECTION DETECTION

(71) Applicant: Cooper Technologies Company, Houston, TX (US)

(72) Inventors: Frank Anthony Doljack, Pleasanton, CA (US); Hundi Panduranga Kamath, Los Altos, CA (US)

(21) Appl. No.: 14/190,811

(22) Filed: Feb. 26, 2014

Related U.S. Application Data
(60) Provisional application No. 61/789,300, filed on Mar. 15, 2013.

(51) Int. Cl. H02J 1/00

(52) U.S. Cl. CPC H02J 1/00
USPC 307/29

(57) ABSTRACT

A multi-port power switch device may intelligently detect whether a portable electronic device is connected to one of the output ports provided. The output ports can automatically be switched on and off as needed depending on whether they are connected to a portable electronic device.

### CROSS REFERENCE TO RELATED APPLICATIONS

This application claims the benefit of U.S. Provisional Patent Application Ser. No. 61/789,300 filed Mar. 15, 2013, the complete disclosure of which is hereby incorporated by reference in its entirety.

This application also relates in subject matter to the co-pending and commonly owned U.S. patent application Ser. No. 13/662,988 filed Oct. 29, 2012 and claiming the benefit of U.S. Provisional Patent Application Ser. No. 61/556,577 filed Nov. 7, 2011.

This application also relates in subject matter to the co-pending and commonly owned U.S. patent application Ser. No. 13/301,455 filed Nov. 21, 2011 and claiming the benefit of U.S. Provisional Patent Application Ser. No. 61/476,904 filed Apr. 19, 2011.

### BACKGROUND OF THE INVENTION

The field of the invention relates generally to electronic controls for minimizing energy consumption of electrical appliances and devices when not in active use, and more specifically to electronic controls, systems and methods for power converters and charger devices for use with portable electronic devices.

For various reasons, electrical energy consumption is being increasingly scrutinized by residential and business customers. Much effort has been made in recent years to provide electronic appliances of all types that consume reduced amounts of electrical energy in use. Such appliances have been well received in the marketplace and are highly desirable for both residential and commercial consumers of electrical power. While great strides have been made in providing electrical appliances that reduce electrical energy consumption compared to conventional appliances, the appetite for still further energy consumption savings remains.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is a perspective of an exemplary embodiment of a smart power strip device.

FIG. 2 schematically illustrates an exemplary system including control circuitry for the smart power strip device shown in FIG. 1.

FIG. 3 schematically illustrates an exemplary implementation of the control circuitry shown in FIG. 2.

FIG. 4 illustrates another exemplary control circuit for the smart power strip device shown in FIG. 1.

FIG. 5 illustrates another exemplary control circuit for the smart power strip device shown in FIG. 1.

FIG. 6 illustrates another exemplary control circuit for the smart power strip device shown in FIG. 1.

FIG. 7 illustrates another exemplary control circuit for the smart power strip device shown in FIG. 1.

FIG. 8 illustrates another exemplary control circuit for the smart power strip device shown in FIG. 1.

FIG. 9 illustrates another exemplary control circuit for the smart power strip device shown in FIG. 1.

FIG. 10 illustrates another exemplary control circuit for the smart power strip device shown in FIG. 1.

FIG. 11 illustrates another exemplary control circuit for the smart power strip device shown in FIG. 1.

FIG. 12 illustrates another exemplary control circuit for the smart power strip device shown in FIG. 1.

FIG. 13 illustrates another exemplary control circuit for the smart power strip device shown in FIG. 1.

FIG. 14 illustrates another exemplary control circuit for the smart power strip device shown in FIG. 1.

FIG. 15 illustrates a first exemplary state detection algorithm for the smart power strip device shown in FIG. 1.

FIG. 16 illustrates a second exemplary state detection algorithm for the smart power strip device shown in FIG. 1.

### DETAILED DESCRIPTION OF THE INVENTION

A variety of portable or mobile electronic devices are known and in widespread use. Such portable or mobile electronic devices include devices such as cellular phones, smart phones, notebook or laptop computers, tablet computers, portable DVD players, audio and video media entertainment devices, electronic reader devices, portable gaming devices, portable global positioning system (GPS) devices, digital camera devices, and video recorders, among others. Such devices are conveniently enjoyed by scores of consumer electronic users worldwide and are highly desirable.

Such portable electronic devices are generally lightweight and relatively small, hand held devices that are easily moved from place to place. Such portable electronic devices typically include internal or on-board rechargeable battery power supplies. Because of the on-board power supplies, power cords and the like are not needed to operate the device, and the devices may be fully operational independently from any location of an external power supply for a limited time corresponding to the energy storage of the on-board power supply. The limited time may vary depending on actual use of the device.

Power adapters or converters, sometimes referred to as chargers, are available for such portable electronic devices. The chargers include power cords that interconnect the portable electronic device with an external power supply. Such chargers may convert, for example, AC electrical power from an external power supply, such as a commercial or residential power mains supply via a conventional power outlet, to appropriate DC power to power the electronic device. As another example, the converter may convert electrical power from a higher voltage external DC power supply, such as a vehicle battery power system, to appropriate DC power to operate the electronic device. When the portable electronic devices are connected to such external power supplies via the charger and associated cords, power is made available from the external power supply through the charger to recharge the battery of the device and/or otherwise power the device via the external power supply.

Many consumers tend to plug the chargers for such devices into respective wall outlets and leave them plugged-in, whether or not the charger is actually connected to the portable electronic device and being used. Instances wherein a charger is connected to a mains power supply via a wall outlet, but not to a portable electronic device, are sometimes referred to as a no-load state or a no-load condition of the charger.

Many consumers fail to realize that conventional charger appliances, when connected or plugged-in to an external power supply, will continuously consume electrical power in a no-load state. In other words, if left plugged-in to an external power supply, conventional chargers will operate to convert power, and hence consume power, even when the portable device is not connected to the charger. There is no benefit to such energy consumption in a no-load state. It is simply wasted power, and according to some, wasted power of the worst kind because it is completely avoidable, very common, and frequently overlooked.

Conventional charger devices also tend to use more energy than is required to charge a battery (or batteries) for portable electronic devices. This is because the charger is typically operated for much longer periods than is actually necessary to charge the battery of the device. Many consumers may not know that many types of chargers continue to draw power even after full charging of the battery or batteries in the electronic device has been achieved. In some cases, indicator lights and the like are provided to indicate to a user when the battery is charged, but only the most attentive consumers will monitor the battery charging closely and respond promptly to such indicators.

Further, most portable electronic devices nowadays enter a low power state, sometimes referred to as an idle state, when not in active use. Such idle states are provided to conserve the battery power and may allow for longer use of the devices before having to recharge the batteries. In many cases, when entering such an idle state the electronic device may appear to the observer to power down and turn itself off. Often, however, the device is never truly “off” in the idle state. This is perhaps counterintuitive to many consumers, and is compounded by the issues above, for the idle state may be entered while the device is connected to the charger. When this occurs, electronic devices in the idle state will consume power from the external power supply via the charger if it is connected.

Many consumers nowadays may own multiple portable electronic devices and may also own multiple chargers for their portable electronic devices. For households in which each member owns one or more devices and chargers, many of which will remain plugged-into external power supplies when not used for charging, the issues are multiplied. The proliferation of business users of such portable electronic devices has in many cases led consumers to own more than one charger and keep them in different locations (e.g., at home and at work) and often the chargers are plugged-in. When traveling, consumers are known to take their chargers with them and while they sleep, plug the chargers in to charge their electronic devices.

According to some reports, 10% to 15% of the typical electrical energy consumption per year in the typical household may be attributable to power consumed by electronic devices and appliances when in an idle state, a standby state, or in the case of charger appliances, a no load state. Hundreds of dollars per year may accordingly be spent in such households for powering various electronic appliances and devices when not in active use. Such power consumption is sometimes referred to as “vampire power” because it is both unsuspecting to many consumers and negatively parasitic by nature. Given the apparently never-ending proliferation of consumer electronic devices, such issues are becoming of increasing concern. For the typical household, the number of electronic devices and appliances contributing to vampire power issues is likely to grow over time, and as such these problems are likely to increase over time.

While efforts have been made to educate and inform energy consumers of such issues, the most typical remedy provided is to advise consumers to unplug their electronic devices and appliances, including chargers, when not in actual use to avoid wasted energy consumption. For many consumers, however, this is inconvenient and, in some cases, impractical advice.

For various reasons, electrical outlets are not always easily accessible, such that plugging in appliance devices, including but not limited to chargers, in certain locations can simply be challenging. In such cases once a charger device has been plugged-into a power outlet, the incentive for a user to unplug it is minimal. Indeed, for avid consumer electronic users, just finding enough outlets to charge their devices can be a challenge, especially when traveling. Also, and especially for frequently used portable electronic devices needing frequent charging, many consumers find it simply easier to plug their chargers in at a convenient location and leave them in place rather to plug and unplug the chargers each time they are used. For some consumers with physical impairments, they may not be able to plug and unplug the charger devices to save energy even if they wanted to. Finally, there is, of course, a segment of the population that simply remains unaware of vampire power consumption issues, does not fully understand it or appreciate it, or has simply chosen to ignore it.

Adapters and chargers are available for powering portable electronic devices from vehicle electric systems as well, with similar issues and results. Modern vehicles today are typically provided with a number of power outlets distributed throughout the vehicle to accommodate a number of such portable electronic devices at various locations in the vehicle. However, many a vehicle owner has encountered a dead battery because of a connected portable electronic device that drained the vehicle battery while the vehicle was parked with the ignition off for some period of time. Such surprises are, of course, unwelcome, and this is another area where many consumers may fail to understand how the portable devices and/or their chargers or adapters actually operate. Such confusion is perhaps only increased as some types of portable devices, when used with their chargers/adapters in a vehicle, are designed to recognize when the ignition has been turned off and power themselves down to minimize any chance of draining the vehicle battery. While some devices certainly do effectively function in such a manner, not all of them do and problems remain.

Likewise, modern vehicles can include intelligent features to disconnect devices to prevent the vehicle battery from being depleted. Connected devices may, for example, automatically be disconnected after a certain period of time after the vehicle ignition is turned off. Such features, however, may typically be switched on or off by the user of the vehicle, knowingly or unknowingly. Thus, confusion and problems may nonetheless result that will defeat even well designed vehicle system features to prevent inadvertent power drains of the vehicle battery.

While various systems and methods have been proposed for counteracting wasteful energy consumption of the type described in various applications, none is believed to have provided a simple, practical, convenient and affordable solution. Rather, existing systems and methods designed to address such issues are believed to be complicated, unnecessarily expensive, impractical or inconvenient, and subject to human error.

The proliferation of portable electronic devices has produced an array of different AC/DC charging devices corresponding to each device. Power strips providing additional power outlets are sometimes needed just to accommodate the various charging devices. Some types of power strips are known that attempt to address vampire power consumption issues. Typically, power strips of this type may automatically disconnect one of or more of the power receptacles once the device connected to it stops drawing power (which may occur when a battery of a portable devices is fully charged or if the device is turned off), but then involve a switch or pushbutton to turn them back on when needed. This type of power strip can be confusing to some users and inconvenient for others. Improvements are desired.

Exemplary embodiments of a smart power strip are described herein that consolidate charging functions of various types into a single device that can, in turn, be used with multiple portable electronic devices having different power requirements. Moreover, the smart power strip saves the vampire power associated with AC/DC charging of the various portable electronic devices when those devices are not plugged-in and connected to the power strip.

Implemented in processor-based controls, the inventive controls, systems and methods eliminate wasted no-load power consumption of conventional charger devices, and also obviate any need to unplug the electrical device or appliance from the main power supply when not in use. Users of electronic devices may use one device to power and/or charge a variety of different electronic devices, while achieving substantial energy savings. Any of the electronic devices and appliances discussed above may benefit, as well as others. The devices and applications described herein are exemplary only, and are provided for the sake of illustration rather than limitation. Any electric appliance or device presenting similar energy consumption issues to those described above may benefit from the inventive concepts disclosed, whether or not specifically referenced in the present disclosure.

Controls, systems and methods for operating an electrical device such as a multi-port charger appliance or power strip are described hereinbelow wherein the device detects whether or not it is connected to a portable electronic device, and based upon such detection can intelligently connect or disconnect the charger from an external power supply so that it consumes no power from the external power supply. Exemplary embodiments of charger devices and methods are directed specifically in the examples disclosed to a battery charger that is capable of providing charging power to the portable device through a standard cable that connects to the portable device via a standardized input, although other variations are possible. For example, the intelligent charging features described below can alternatively be integrated into a wall outlet or a power receptacle in a vehicle battery system to provide intelligence regarding whether the wall outlet or power receptacle is connected to an electronic device or another power receiving device and avoid wasteful power consumption.

In contemplated embodiments, the multi-port charger appliance specifically disconnects itself from the external power supply, sometimes referred to herein as a mains power supply, when battery charging via the multi-port charger appliance is not needed. This is accomplished via active monitoring of control inputs that indicate when charging power is required (or not) so that the multi-port charger appliance may disconnect or reconnect the mains power on demand. For discussion purposes, charging power is required or demanded when a power receiving device (such as a portable electronic device or appliance) is connected to the multi-port charger appliance using a standard charging cable or cord that is compatible with the portable device. Via monitoring of at least one of the signal lines or a power bus that is present in the standard cable, and specifically by monitoring a voltage of one or more of the signal lines and the power bus and detecting changes in the voltage, connection and disconnection of the standard cable to and from the portable electronic device can be reliably detected. Such state detection for the multi-port charger appliance can then be utilized as a basis for the charger controls to disconnect or reconnect to the mains power supply.

The multi-port charger appliance, sometimes referred to herein as a smart power strip, may automatically connect and disconnect power/charger ports based on whether or not portable electronic devices are plugged-in to the power strip. Accordingly, the power strip is equipped with automatic device connection detection capability that works for all of the portable electronic devices that use the smart power strip. Exemplary device detection schemes are described below. Method aspects will be in part apparent and in part explicitly discussed in the description below.

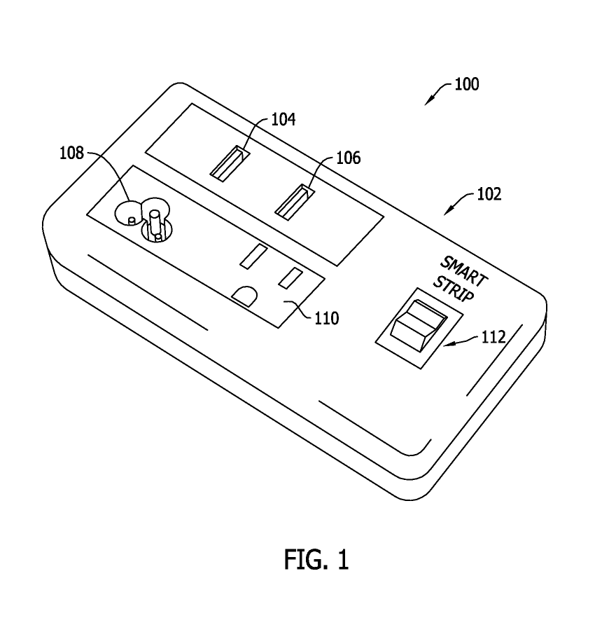

Turning now to FIG. 1, an exemplary embodiment of a smart power strip device 100 including a body 102 and multiple power output ports 104, 106, 108 and 110 in a single device package is shown. The power output ports 104, 106, 108 and 110 are respectively configured to establish mechanical and electrical connection with different types of portable electronic devices as well as other types of devices. As explained below, the output ports 104, 106, and 108 provide various types of direct current (DC) power suitable for powering a variety of portable electronic devices, and the output port 110 provides alternating current (AC) power for other types of devices.

The smart power strip device 100 may accordingly work universally to charge different types of portable electronic devices, and eliminates a need for multiple and separate charger appliances that would otherwise be necessary to charge a corresponding number of different type of portable electronic devices. In the example shown all the power output ports 104, 106, 108 and 110 are provided on a common face or surface of the body 102, although in other embodiments at least one of the various power output ports 104, 106, 108 and 110 could be provided on different faces or surfaces of the body 102 from the others.

As explained in detail below, the smart power strip device 100 includes portable electronic device connection capability sensed by monitoring a voltage (power) bus of connected portable electronic devices. Monitoring signal lines that may be present in portable electronic devices is additionally sensed to detect portable electronic device connection.

The smart power strip device 100 defines a multi-port power strip that converts AC mains power to DC power for various portable devices by automatically turning on an included AC/DC converter internal to the body 102 and connected to each port 104, 106, 108 when connection to the respective ports 104, 106, 108 is made by a portable electronic device. Portable device connection detection is automatic as further described below and operates without any action by the user other than plugging into one of the ports provided on the device 100. Unlike conventional power strip devices, the device 100 avoids the need to have the user push a button or switch to otherwise turn on the particular port in which the user has plugged-in a portable electronic device. Automatic detection further allows the AC/DC converters for each port to otherwise be disconnected (i.e., electrically isolated) from the mains when no device is present, which avoids so-called vampire energy consumption,

The power strip device 100 is generally configured to provide the particular DC power required by various portable devices that otherwise operate on battery power and need recharging power or operating power when used together with a power source. Exemplary portable devices that may be used in combination with the power strip device 100 include cellular phones, smart phones, notebook or laptop computers, tablet computers, portable DVD players, audio and video media entertainment devices, electronic reader devices, portable gaming devices, portable global positioning system (GPS) devices, digital camera devices, and video recorders, among others. Many of such known portable electronic devices require a 5 volt power supply derived from a Universal Serial Bus (USB) port while others require a 19 volt power supply through either special or standard power connectors.

The exemplary power strip device 100 is therefore configured to accommodate a plurality of different requirements of various portable electronic devices. As shown in FIG. 1, the power strip device 100 includes a first output port 104 configured as a 1 ampere, 5 volt USB port. The port 104 provides suitable power to electronic devices such as cellphones. The second port 106 is configured as a 2.4 ampere, 5 volt USB port that provides suitable power to electronic devices such as tablet computers. The third port 108 is configured as a charging port that can provide, for example, 19 volts at a power level of 90 watts. The fourth port 110 is configured as a standard AC plug supplying AC power to any device or appliance.

The fourth port 110 may also be associated with a user-activated power switch 112. The switch 112 may be used to manually connect or disconnect the port 110 from a mains power supply, while the other ports 104, 106, 108 are automatically switched on and off without user input as described below to eliminate wasteful, vampire power issues.

In one contemplated embodiment, each of the three exemplary power ports 104, 106, and 108 may be driven by their own AC/DC converter (included in the body 102 of the device 100) which is individually operated on or off, depending upon a sensed presence or absence of an electronic device connection to the respective port 104, 106, and 108. That is, the device 100 may include three power converters individually operable on demand to supply output power to each port 104, 106, and 108 when a portable electronic device is connected to each port.

In another embodiment, the device 100 may include a single (i.e., only one) AC/DC converter in the body 102, with the single converter providing multiple outputs each respectively supplying power to each port 104, 106, and 108, The single converter may be operated on by the presence of at least one portable electronic device connected to a port and operated off by the absence of a portable electronic device connected to any one of the ports 104, 106, and 108.

In still another contemplated embodiment, the device 100 may include two AC/DC converters in the body 102, namely a low power converter that services the two exemplary low power ports 104 and 106 that each deliver 5 a volt power supply, and another AC/DC converter that is dedicated to the high power port 108 delivering a 19 volt power supply. Automatic portable electronic device detection may operate to turn on or off the AC/DC converter associated with the respective low power port 104, 106 or the high power port 108.

It should be recognized that the smart power strip device 100 may be configured with more or less than the three ports 104, 106, 108 as shown. Many more combinations of ports and converters are possible having practically any number of ports, and ranging from a single multi-port AC/DC converter that services all ports provided to an AC/DC converter dedicated to each individual port.

In all cases the DC ports 104, 106, 108 require automatic detection of a portable electronic device when it is plugged-in so that the power strip device 100 provides to the user an experience that might be called “plug and forget”. No additional pushbutton or switch needs to be pressed to activate the device 100.

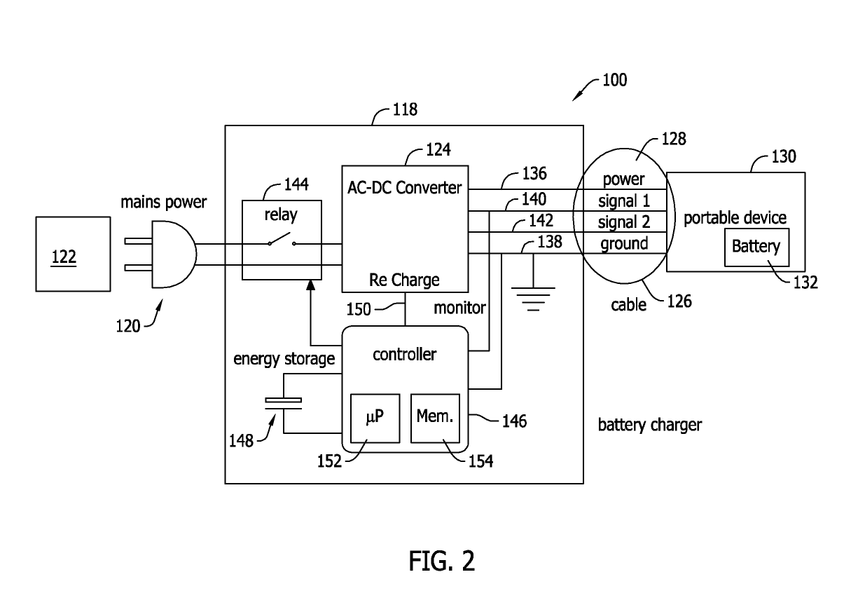

FIG. 2 schematically illustrates an exemplary system including the smart power strip device 100 interfacing a mains power supply and a portable electronic device, including power conversion circuitry, control elements and associated control circuitry 118 in the smart power strip device 100 that provide for device state detection to determine whether or not electronic devices are connected to the ports 104, 106 and 108 and to automatically connect and disconnect from the mains power supply accordingly.

The smart power strip 100 in the example shown includes a plug 120 connectable to a mains power supply 122 via a standardized outlet, control circuitry 118 including a converter 124, a cable or cord 126 and a connector 128 that establishes an electrical connection with a portable electronic device 130 via a mating connector provided on the electronic device 130.

The smart power strip 100 including the control circuitry 118 can be separately provided from the power supply 122, or in some embodiments may be integrated in the power supply via a wall mounted outlet or a power receptacle mounted in a supporting structure in a vehicle environment, which may be adapted to directly receive the cable 128 supplying power to the electronic device 130. That is, the plug 120 in some cases may be optional and may be omitted. Any power conversion and monitoring described below may be provided in the smart power strip 100 as a stand-alone device which may be placed on a countertop, desk or table for example. Alternatively the smart power strip device 100 and its power conversion and monitoring circuitry may be integrated into a wall mounted outlet, a furniture mounted outlet, or power receptacle in a vehicle environment. Whether provided as a conventional adapter with the plug 120, or as an intelligent power outlet or receptacle including the output ports 104, 106 and 108, however, the control features operate in a similar manner as described below in relation to various exemplary embodiments.

Depending on the detected state of the smart power strip device 100 as described below, the control circuitry 118 can disconnect and electrically isolate itself from the mains power supply 122, as well as reconnect to the mains power supply 122 when charging power is needed. That is, the control circuitry 118 can intelligently decide whether power from the external mains power supply 122 is needed (or not) to charge the internal or on-board battery power supply 132 of the portable electronic device 130, and thus operate the smart power strip device 100 with no wasted power when it is not needed by the electronic device 130. The smart power strip device 100 is therefore sometimes referred to as a zero power smart strip as it consumes no power when it is disconnected form the mains power supply 122.

The mains power supply 122 may, for example, supply an alternative current (AC) mains voltage such as 120V, 60 Hz, single phase power common to residential power systems, although other types of AC power supplies are possible operating at different voltages, different frequencies or having various numbers of phases. It is also recognized that the mains power supply 122 may alternatively be, for example, a 12V to 15V, direct current (DC) power supply such as a storage battery or batteries of a vehicle electrical power system. In a vehicle system, the battery or batteries corresponding to the mains power supply 122 may be part of a main power system or an auxiliary power system for operating accessories and auxiliary applications of the vehicle. While one type of interface plug 120 is shown in FIG. 2, it is recognized that differently configured interface plugs may be necessary to connect the smart power strip device 100 and the mains power supply 122 to various types of AC and DC mains power supplies. Such interface plugs are generally known and are not described further herein.

In the context of a vehicle and various electrical devices and appliances connected to the vehicle electric system, the vehicle may in various exemplary embodiments be a passenger vehicle (e.g., motorcycles, cars, trucks and buses designed for road use), a commercial vehicle (e.g., tractor trailers, mail trucks, delivery vehicles, garbage trucks and haulers, forklifts), construction vehicles (e.g., diggers, backhoes, bulldozers, loaders, and earthmoving equipment, graders, rollers, dump-trucks), vehicles of all types equipped for military use, vehicles designed for off-road use (e.g., tractors and other farm vehicles, four wheel drive vehicles, sport utility vehicles, all-terrain vehicles, dirt bikes, dune buggies, rock crawlers, sandrails, snowmobiles, golf carts), various types of marine vehicles (e.g., ships, boats, submarines, personal watercraft and other vessels), various types of aircraft (e.g., planes and helicopters), space vehicles (e.g., missiles, rockets, satellites and shuttles), recreational vehicles (e.g., RVs and camper trailers), or other modes of transporting persons or things that are propelled and/or powered by mechanical, electrical and other systems and subsystems.

It is also contemplated that in some embodiments the “mains power supply” 122 as schematically shown in FIG. 2 could be performed by another electronic device, whether or not a portable electronic device. That is, certain types of electronic device are capable of powering other electronic devices using known connection ports and protocols. It is therefore possible that a first electronic device could be connected to an AC or DC mains power supply (whether or not through a charger device), and the first device could supply output power to a second electronic device 130. That is, an indirect connection between the smart power strip device 100 and the mains power supply 122 may possibly be established through another electronic device or another electrical appliance. In such a scenario, the converter circuitry 124 may or may not be utilized to supply appropriate charging power to the device 130. As one example, a portable electronic device such as a smart phone may be interfaced with a computer via a USB port or other interface, and the computer may accordingly supply power to the portable electronic device either from its own battery storage or from the mains power supply when the computer is connected thereto with its own power cord or docking station.

It should now be clear that, if used with an appropriate smart power strip device 100, the portable electronic device 130 may interface with various types of mains power supplies 122. When standardized cables 126 and connectors 128 are utilized with compatible electronic devices 130, it is possible for a single smart power strip device 100 to supply charging power to a plurality of electronic devices 130 via the various ports 104, 106, 108 provided.

The control circuitry 118 in the example shown includes an AC/DC converter (or converter circuitry) 124 which, when connected through the smart power strip device 100 to the mains power supply 122, supplies battery charging power to the portable device 130 over a power line 136 that is included within the standard cable 126. It is understood, however, that in alternative embodiments the converter circuitry 124 may be a DC/DC converter depending on the mains power supply being utilized.

The cable 126 in the example shown includes a power line 136, a common ground 138 and signal lines 140 and 142. In other embodiments, other numbers of signal lines may be provided. The cable 126 may include a connector at one or both ends thereof in order to establish mechanical and electrical connection with the portable device 130 and the control circuitry 118 of the smart power strip device 100 if desired. The portable electronic device 130 and the smart power strip device 100 may be provided with mating connectors to those provided on the cable 126 to establish the mechanical and electrical connections. Such connectors may be one of a variety of known plug and socket type connectors or other types of connectors known in the art. In another contemplated embodiment, the cable 126 may be pre-attached to the smart power strip device 100 in a permanent manner such the user need only be concerned with making or breaking the mechanical and electrical connection with the portable electronic device 130.

The smart power strip device 100 as shown further includes a switch 144 such as a latching relay familiar to those in the art. The switch 144 may include one or two poles, for example, and is selectively operable to opened or closed positions to respectively disconnect or connect the mains power 122 from the converter circuitry 124 in response to a control signal provided by a monitoring device or controller 146. When the switch 144 is opened as shown in FIG. 2, the converter circuitry 124 is electrically isolated from the mains power supply 122. As a result, no current flows from the mains power supply 122 to the converter circuitry 124 and no power is consumed from the mains power supply 122. When the switch 144 is closed, however, an electrical path is completed between the mains power supply 122 and the converter circuitry 124 through which current may flow from the mains power supply 122 to the converter circuitry 124, which supplies output power to the cable 126 via the power line 136. The power line 136 in the cable 126, in turn, may supply charging power to recharge the battery 132 in the electronic device 130 when the cable 126 is connected to the device 130.

The monitoring device 146, sometimes referred to as a controller, derives energy for continuous operation, as also shown in FIG. 2, from an energy storage device 148 while the mains power 122 is disconnected from the converter circuitry 124 via the switch 144. In various contemplated embodiments, the energy storage device 148 may be a capacitor or a battery. The energy storage device 148 in one contemplated embodiment is preferably a supercapacitor generally having less storage capacity than a battery of similar size, although other energy storage devices including but not limited to batteries could potentially be used in other embodiments.

When the mains power 122 is connected via the switch 144, the energy storage element 148 is recharged via a recharge output 150 of the converter circuitry 124. The controller 146 operates the switch 144 to connect and disconnect the mains power supply 122 and the converter 124 to ensure that the energy storage element 148 is able to power the state detection features described hereinafter.

In the example shown, the controller 146 is a programmable processor-based device including a processor 152 and a memory storage 154 wherein executable instructions, commands, and control algorithms, as well as other data and information to operate the power strip device 100 are stored. The memory 154 of the processor-based device may be, for example, a random access memory (RAM), and other forms of memory used in conjunction with RAM memory, including but not limited to flash memory (FLASH), programmable read only memory (PROM), and electronically erasable programmable read only memory (EEPROM).

As used herein, the term “processor-based device” shall refer to devices including a processor or microprocessor as shown for controlling the functionality of the device, but also other equivalent elements such as, microcontrollers, microcomputers, programmable logic controllers, reduced instruction set (RISC) circuits, application specific integrated circuits and other programmable circuits, logic circuits, equivalents thereof, and any other circuit or processor capable of executing the functions described below. The processor-based devices listed above are exemplary only, and are thus not intended to limit in any way the definition and/or meaning of the term “processor-based device.”

The controller 146 in the exemplary embodiment shown in FIG. 2 monitors a voltage condition of the first signal line 140 to detect any voltage change on the first signal line 140. More specifically, the controller 146 may apply a voltage to the first signal line 140 via the energy storage element 148 at a first voltage and measure the voltage via a feedback input to the controller 146. When the cable 126 is connected to the portable device 130 the monitored voltage on the first signal line 140 will be different from the applied voltage. The controller 146 accordingly detects this change in voltage on the first signal line 140, and in response operates the relay 144 to re-connect the mains power supply 122 to the converter circuitry 124. Electrical power, from the external mains power supply 122, is then delivered by the converter circuitry 124 to the portable device 130 via the power line 136 in the cable 126. At the same time, the energy storage device 148 is recharged to its full capacity.

When the cable 126 is disconnected or removed from the portable device 130, the voltage on the first signal line 140 again changes. The change is detected by the controller 146, which continues to monitor the first signal line 140 while the battery 132 of the portable device 130 is charged. In response to disconnection of the cable 126 from the portable electronic device 130, the controller 146 operates the relay 144 so that mains power 122 is disconnected from the converter circuitry 124. At this point, the converter circuitry 124 receives no power from the external mains power supply 122, and the controller 146 is powered, for monitoring purposes only, by the energy storage device 148. In this manner, the power strip device 100 wastes no energy during the time a portable device 130 is disconnected from it (i.e., the no-load state discussed above wherein the cable 126 is disconnected from the electrical device 130).

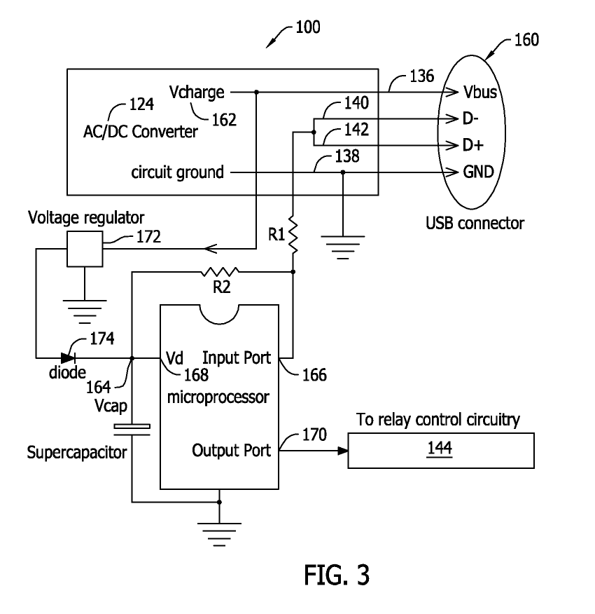

Turning now to FIG. 3, further details of one exemplary implementation is described. The standard cable 126 (FIG. 2) in this example is a Universal Serial Bus (USB) cable with a USB connector 160 interfacing to the smart power strip device 100. The power line 136 in such a USB cable interfaces with a corresponding contact shown as Vbus in the USB connector 160. The signal lines 140 and 142 interface with corresponding signal contacts shown as D− and D+ in the USB connector 160, and the ground line 138 interfaces with a corresponding contact in the USB connector shown as GND. When the USB connector 160 is interfaced with the device 130 (FIG. 2), corresponding contacts in the device 130 are electrically connected to the Vbus, D− and D+ contacts in the USB connector 160.

When the converter circuitry 124 is connected to the mains power supply 122, the converter circuitry 124 outputs a voltage 162 shown as Vcharge in FIG. 2 onto power line 136 and Vbus in the USB connector 160. In this example, the USB Specification defines Vcharge to be 5 volts DC. The signal lines 140 and 142 (D− and D+) are shorted together in one example within the smart power strip device 100. According to the USB-IF Battery Charging Specification this shorted condition of the signal lines 140 and 142 can be used by the portable electronic device 130 (which is provided with a mating connector to the connector 128 shown) as an indication that the portable device 130 is connected to a Dedicated Charger Port or dedicated charger device.

The shorted signal lines 140 and 142 are biased through biasing resistors R1 and R2 to a voltage equal to Vcap 164. Vcap 164 corresponds to the voltage supplied by the energy storage device 148 or a supercapacitor in the example of FIG. 3. Vcap 164, in one example, is set to 3.6 volts, although other voltages could be used if desired. When no portable device 130 is connected via the connector 160, the signal lines 140 and 142 (D− and D+) are accordingly biased to Vcap or 3.6 volts. This biased voltage is sensed by the controller 146 (a microprocessor in this example) at its input port 166, which in turn is connected to the node between R1 and R2. In one example, R1 is selected to be 10 Kohms and R2 is selected to be 1.0 Mohms.

The controller 146 includes a microprocessor and is typically a very low power consuming device. Suitable microprocessor devices are known for use as the controller 146, including but not limited to a microcontroller having part number PIC16LF1823 manufactured by Microchip (www.microchip.com) of Chandler, Ariz. Programmatically, the microcontroller 146 spends most of its time in a deep sleep mode when no portable device 130 is present (i.e., the no-load state wherein the cable 126 is not connected to the portable device 130). In the deep sleep mode such a microcontroller 146 draws only a fraction of 1 microamperes of current from its voltage supply at input 168, also shown as Vd in FIG. 3. Since Vd is supplied by the energy storage device 148 (the supercapacitor in this example), it takes a very long time before Vcap 164 decreases to a point where the energy storage device 148 needs to be recharged.

The input port of the microcontroller 146 is programmatically configured so that any voltage change on it will wake up the microprocessor 146 from its deep sleep mode. Such a port programming feature is known and not described further herein.

When no portable device 130 is present, a stable voltage of magnitude Vcap is presented at the input port 166 of the microcontroller 146. The moment a portable device 130 is connected (i.e., the cable 126 and connector 128 are mated with the portable electronic device 130 and its connector 160), the signal lines 140 and 142 (D− and D+) together will be pulled down from the voltage Vcap to a voltage of nearly 0 volts. Consequently, the input port voltage at the input port 166 will similarly be pulled down. This voltage change, detected via the input port 166 of the controller 146, will wake up the microcontroller 146. Programmatically, the microcontroller 146 will verify that the input voltage has changed to a value that indicates a portable device 130 is present (i.e., about 5 volts in the USB example). Once this is verified, the microcontroller 146 will then output a voltage at its output port 170 as a signal command to operate the relay 144 in order to connect the mains power supply 122 to the converter circuitry 124 in the charger 100. Subsequently, the voltage 162 (Vcharge) will appear from the AC/DC converter 124 and provide charging power to the Vbus line or power line 136. Additionally, the voltage 162 (Vcharge) appearing from the converter circuitry 124 will recharge the energy storage device 148 (a supercapacitor in this example) through a voltage regulator 172 and a diode 174. The voltage regulator 172 steps Vcharge (5 volts in this example) down to Vcap (3.6 volts) and the diode 174 prevents the supercapacitor 148 from discharging back through the voltage regulator 172 during times when the converter circuitry 124 is disconnected from the mains power supply 122 via the relay switch 144.

Once the switch 144 connects the converter circuitry 124 to the mains power supply 122, the microcontroller 146 continues to monitor the magnitude of the voltage present at the input port 166. This input voltage will return to a value of Vcap (e.g., about 3.6 V in this example) when the cable 126 and connector 128 are detached from the portable device 130 and the no-load state results. Once the microcontroller 146 senses this no-load state or condition, it will set the output voltage at the output port so as to cause the relay switch 144 to disconnect the mains power supply 122 from the converter circuitry 124. The microprocessor 146 at this point returns to the deep sleep state and awaits for another change in state of the smart power strip device 100, corresponding to its re-connection with a portable device 130, or perhaps connection to another portable device 130 that is also compatible with the charger 100. While one converter 124 and one device 130 is shown in FIG. 2 for the sake of discussion, it should be noted that the device 100 actually includes multiple power output ports and in some cases multiple converters.

To account for a possible circumstance where the electronic device 130 is re-connected (or another portable device is connected) only after a very long period of time, the microcontroller 146 is programmatically configured to wake up at regular intervals for a short time. This timed wake up feature is commonly found on available microprocessors/microcontrollers. During the wake period the microcontroller 146 measures the voltage Vcap at the input port 166. If the measured voltage value is found to be at or below a threshold value (for example, 2.5 volts), then the microcontroller 146 operates the relay switch 144 in order to connect the mains power supply 122 to the converter circuitry 124 for a fixed or predetermined period of time. During this period of time the converter circuitry 124 recharges the energy storage device 148 back to its fully charged voltage Vcap (about 3.6 volts in this example. At the end of the fixed time period the microcontroller 146 returns to the deep sleep mode after re-setting the timed wake up feature.

If, on the other hand, after the microcontroller 146 wakes up, the microprocessor instead measures a value voltage Vcap at its input 166 that is acceptable (i.e., above the predetermined threshold or about 2.5 volts in this example), the microcontroller 146 immediately returns to the deep sleep mode after re-setting the timed wake up feature.

While operation of the converter circuit 124 to provide a 5V output power to the power line 136 and Vbus has been described, and thus would provide a suitable output for one of the ports 104, 106 (FIG. 1) in the smart strip device, another output could alternatively be provided in the converter circuit 124 to provide a different converter output to the port 108 of the smart power strip device 100. Likewise, another converter circuit, in addition to the converter circuit 124 could be provided and selectively connected or disconnected from the mains power supply 122 using similar control techniques to those described above. More than one controller 146 and energy storage device 148 could be provided to manage any number of output ports provided in the device 100, or alternatively a single controller 146 and energy storage device 148 could manage multiple ports in the device 100.

Further examples of energy management control circuitry and methods are described in the co-pending and commonly owned U.S. patent application Ser. No. 13/662,988 filed Oct. 29, 2012 and claiming the benefit of U.S. Provisional Patent Application Ser. No. 61/556,577 filed Nov. 7, 2011 that enable electronic device connection detection using data signal lines that are present in the connector of many portable devices that receive recharge power for their batteries. The reader is referred to U.S. patent application Ser. No. 13/662,988 for further details of the circuitry and methods, which are applicable in the smart power strip device 100 to the extent used with portable electronic devices having data signal lines and for, example, USB connectors. However, the smart power strip device 100 may additionally include control circuitry providing for automatic portable electronic device connection detection where there are no signal lines present in the power connector of the electronic device. Laptop power supply chargers are one such example wherein conventional power connectors typically do not include signal lines. Rather, in conventional laptop power supply chargers, the power plug contains only a power bus and a ground return line.

It has been found that most, if not all, portable electronic devices when not connected to any charging power supply are designed so that the power bus rests near or at ground potential. This fact provides a basis to facilitate automatic electronic device connection detection via sensing an operating state of the power bus. Various implementations of such automatic device detection are described below. Further examples of circuits and techniques that likewise sense electronic device connection and disconnection are set forth below.

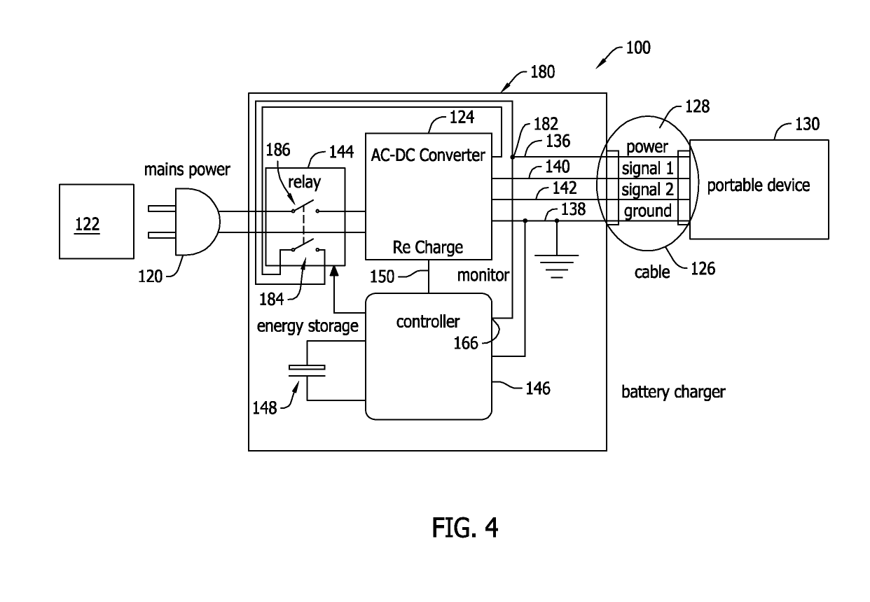

As shown in FIG. 4, the smart power strip device 100 includes an adapted control circuitry 180 that is similar to the control circuitry 118 (FIGS. 1 and 2) in many aspects, but further includes an output 182 of the AC-DC converter 124 that is isolated by an open pole 184 in the power relay switch 144. The voltage applied to the power line 136 and Vbus by the controller 146 will consequently be unaffected by the AC-DC converter output 182 and the voltage on the power line 136 and Vbus will be raised to the full value of the voltage the controller can apply at its output. Isolation from the output of the AC/DC converter 134 via the switch pole 184 is important to electronic device connection detection in this example, because without isolation of the converter output 182 the voltage level applied to power line 136 and Vbus will be severely reduced. When a portable device 130 is connected, the Vbus node and the power line voltage will be pulled to ground and detected by the controller 146. The controller 146 may accordingly wake up and switch the poles 184 and 186 so that the converter circuit 124 receives power from the mains power supply 122. The energy storage device 148 is recharged as described above.

The controller 146 continues to monitor the voltage at its input 166, and when the electronic device 130 is disconnected the voltage at Vbus and the power line 136 drops to ground potential. The controller 146 may then signal the relay 144 to open both switch poles 184 and 186 in the relay. The converter circuit 124 is then electrically isolated from the mains power supply 122 and the converter output is again isolated so that the voltage on the power line 136 and Vbus will be raised to the full value of the voltage the controller can apply at its output. The controller 146 may then go to sleep and monitor the voltage across the energy storage device 148.

Unlike the arrangement shown in FIGS. 2 and 3, the power strip device 100 shown in FIG. 4 does not depend on the signal lines 140, 142 to detect connection of the device 130 to one of the ports. Rather, the device 100 including the circuit 180 shown in FIG. 4 depends on voltage changes on the power line and Vbus to determine whether or not the electronic device 130 is connected or disconnected to one of the output ports 104, 106 and 108 of the device 100, and can control the relay switch 144 accordingly to automatically provide power when needed and also automatically disconnecting power from the mains power supply 122 when not needed.

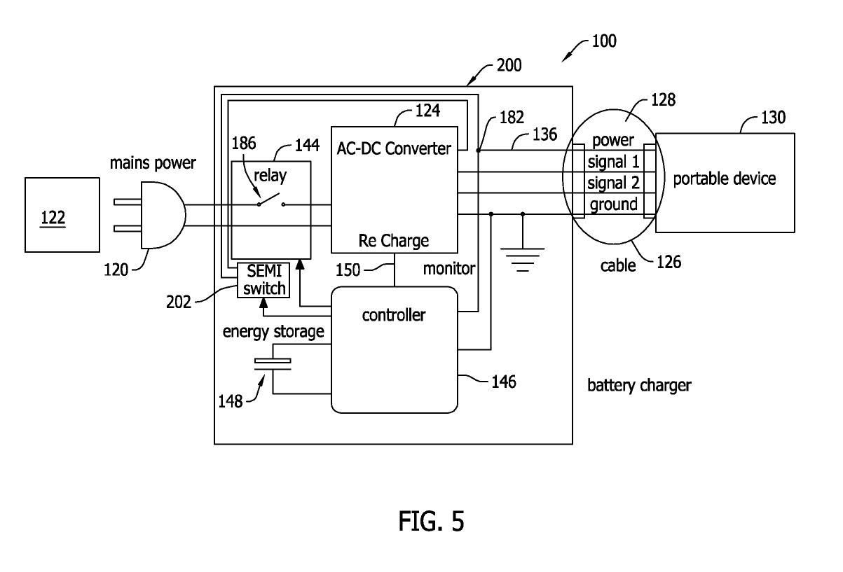

As shown in the FIG. 5, the smart power strip device 100 may include control circuitry 200 that is similar to the control circuitry 180 (FIG. 4) in many aspects. The control circuitry 200 includes a semiconductor switch 202 in lieu of the second pole 184 of the relay 144 as shown in FIG. 4 to accomplish the same purpose of isolating the output of the converter circuit 124 from Vbus and the power line 136. The semiconductor switch 202 may be Metal-Oxide-Semiconductor Field Effect Transistor (MOSFET) that can be controlled by the controller 146. The MOSFET may be an n-type or n-channel MOSFET element having a source, a drain, and a gate. The flow of current between the source and the drain in each MOSFET can be controlled by the voltage applied to the gates as determined by the controller 146.

When the semiconductor switch 202 is turned on it will pass the current that is delivered from the converter circuit output 182 to the portable device 130 when the switch pole 186 is also closed. A semiconductor switch 202 is desirable in that it dissipates very little power itself. For this reason a controllable switch 202 like a MOSFET is preferred over a non-controlled isolating diode such as a Schottky diode. However, a Schottky diode may also be used as an alternative to the semiconductor switch 202 to isolate the converter output.

The functionality of the circuit 200 is otherwise similar to the circuit 180 described above.

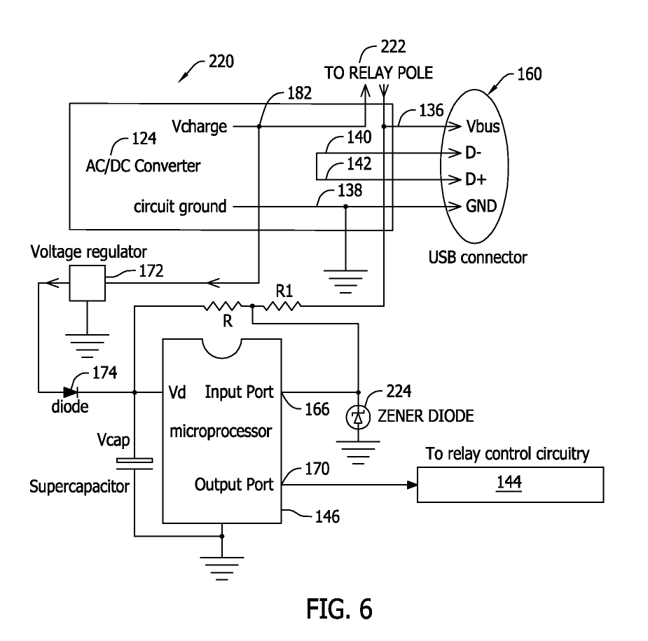

FIG. 6 illustrates another implementation of a control circuit 220 resembling the circuit of FIG. 3 in many aspects, but is adapted for sensing the voltage of the power line 136 and Vbus rather than the signal lines 140, 142 to determine connection or disconnection of an electrical device 130. The circuit of FIG. 6 illustrates a relay pole 222 to isolate the converter output 182 in a similar manner to FIG. 4 although a semiconductor switch 202 could also be utilized as shown in FIG. 5 without any effect upon the operation of the detection scheme.

In the circuit of FIG. 6, while the converter circuit 124 is disconnected from the AC mains 122 there is no voltage present on the Vcharge line and the microprocessor 146 subsequently derives its voltage Vd from the supercapacitor storage element 148, which supplies a voltage of Vcap. This voltage is applied to Vbus through the series arrangement of R and R1. A zener diode 224 is connected to the microprocessor input port 166 and has a clamp voltage equal to or slightly greater than Vcap. The zener diode 224 assures that the port and value of Vcap do not exceed the maximum permissible voltage Vd of the processor 146 when subsequently 5 volts appears on Vbus after device connection. The value of R1 is chosen so that the maximum current rating of the zener diode 224 is not exceeded.

When a portable device 130 is about to be connected its power bus is normally at ground potential. At the instance of connection via the cable connector 128 and the device connector 160, the applied Vbus voltage (equal to Vcap) will be abruptly pulled to ground for at least a short time. The input port voltage will follow to ground, which in turn will wake up the processor 146 from a deep sleep, energy-savings mode of operation. The processor 146 will subsequently command the AC power input relay to turn on as well as the semiconductor switch if it is present. DC voltage (5 volts) will appear at the node Vcharge and power will subsequently flow from the converter circuit 124 to the portable device 130. The energy storage device 148 (a supercapacitor in the example shown) will receive recharge current from the voltage regulator 172 which in turn will maintain a full charge voltage level of Vcap for the energy storage device 148.

The functionality of the circuit 220 is otherwise similar to the circuits 180 and 200 described above.

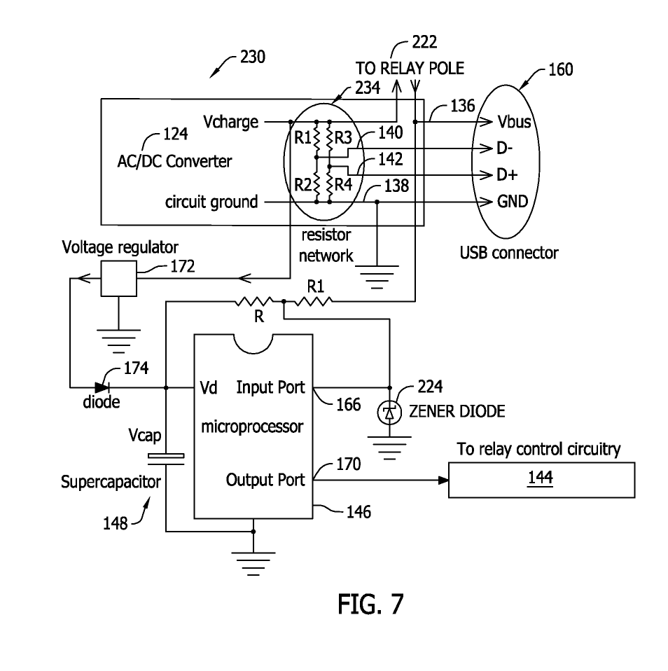

FIG. 7 illustrates a circuit 230 resembling the circuit 220 (FIG. 6) but including a resistor network 234 at the output of the converter circuit 124. The circuit 230 is useful when the portable electronic device 130 does not comply with the USB-IF Battery Charging Specification, but uses an alternative method adopted by the manufacturer of the portable device 130 for determining whether or not the device 130 is connected to a dedicated battery charger.

In the example of FIG. 7, the portable device manufacturer's method of detecting the battery charger involves measuring the voltage on the signal lines 140 and 142 (D− and D+) after Vcharge (about 5 volts in this example) appears on the power line 136 or Vbus. To do so, the resistor network 234 is provided, and in one example the values of the resistances in the resistor network shown are R1=75 Kohms, R2=49.9 Kohms, R3=43.2 Kohms, and R4=49.9 Kohms Analysis easily shows that the network will impress 2.7 volts onto the signal line 140 (D−) and 2.0 volts onto the signal line 142 (D+). After detection of these voltages on the respective signal lines 140 and 142, the portable device 130 then permits charging to proceed.

Device detection sensing to determine whether the electronic device 130 is connected or disconnected from the power strip device 100 is the same as in the circuit 220 (FIG. 6). The resistor network 234 has no affect upon the sensing operation since it is isolated from Vbus.

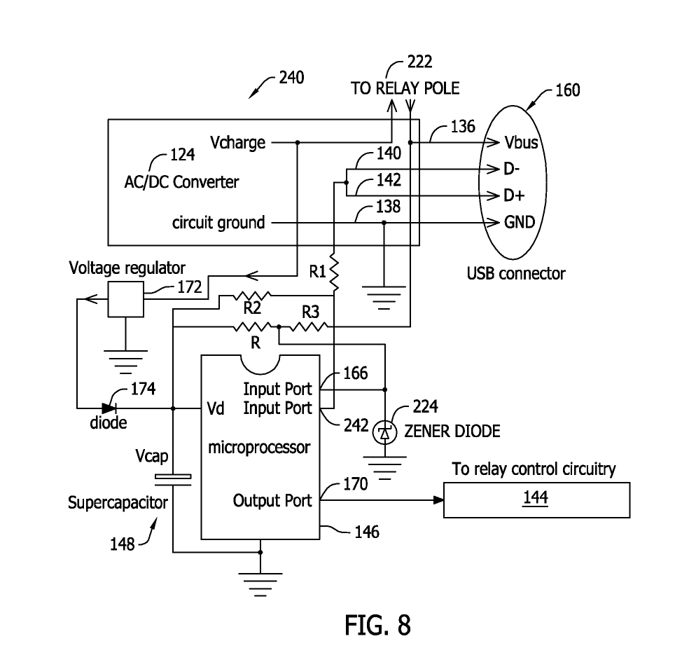

FIG. 8 shows another circuit 240 resembling the circuit 220 (FIG. 6) in many aspects. In the circuit 240, two input ports 166 and 242 of the microprocessor 146 are used for detection. This circuit 240 is useful since some portable devices 130 do not pull-to-ground the signal lines 140, 142 while others do. In such cases usually the device 130 will pull-to-ground the power line 136 and Vbus and hence device connection detection will still be successful. Device connection may be sensed via the voltage change on the power line 136 and Vbus via the input 166 or via a detected voltage change on the signal lines 140, 142 via the input 242 to the controller 146. As such, the circuit 240 will work with most electronic devices 130 regardless of their specific configuration.

A simplified version of the circuit 240 can be configured which eliminates the lower input port 242 by connecting the common node of R1 and R2 to the common node of R and R3, and by combining R and R2 into a single resistor. In this manner pull-to-ground either on Vbus, D signal lines, or both will drive the voltage on the input port 166 to ground or nearly to ground. The controller 146 may then wake up and automatically perform the functions described above.

The foregoing embodiments therefor demonstrate various ways to detect connection of an electronic device 130 by sensing a voltage that is pulled to ground, whether on the power line 136 or the signal lines 140, 142.

One way to detect a voltage pulled to ground is referred to as resistive sensing wherein voltage attributable to current flowing in a resistor is detected at a controller input. There are other ways to sense a voltage pulled to ground, applicable to both power line sensing and signal line sensing, to provide device connection features described above, and any of the may be used to provide still other variations of the circuits described above with similar functionality. Exemplary detection schemes, in addition to resistive sensing techniques, include opto-sensing techniques wherein current flow generates light that may be sensed, capacitive sensing techniques wherein a stored electric charge that is discharged to ground that may be sensed, transformer (inductive) sensing techniques wherein current flow creates a changing magnetic flux that may be sensed, and diode sensing wherein a junction capacitance stores charge that may be sensed when discharged to ground.

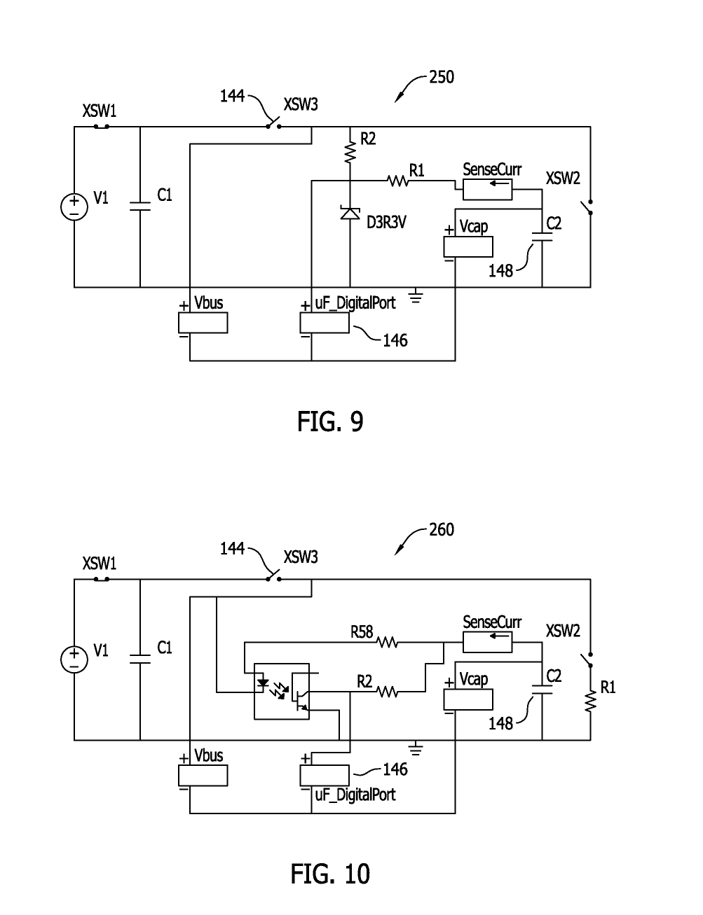

The circuit schematics of FIGS. 9-14 illustrate such alternative sensing techniques that may be utilized to sense device connection where a voltage pull-to-ground occurs on the signal line and Vbus. However, similar sensing techniques can be straight-forwardly applied to a device connection scheme wherein one or both of the signal lines are pulled-to-ground.

As such, in each of FIGS. 9-14 a digital port on a controller 146 such as a microprocessor is used to detect the voltage change on a node. Such digital ports can be usually treated as possessing very high input impedance and are near-perfect voltage sensors. In all of the circuit schematics of FIGS. 9-14 on the left a 5 volt source with an output filter capacitance, C1, represents the power source, and switch XSW3 represents the pole of the relay 144 that isolates the voltage bus from the device detection circuit and is opened or closed by command of the microprocessor 146. On the right switch XSW2 represents connection of a device 130 when it is closed, and no device connection when it is open. Voltmeters are shown connected to nodes Vbus, uP_DigitalPort, and Vcap. An ammeter SensCurr shows the source current from the energy storage device 148 (e.g., a supercapacitor) that is transformed into a voltage signal that wakes up the processor 146 at port uP_DigitalP ort.

FIG. 9 illustrates the resistive sensing technique and accordingly shows a circuit 250 wherein supercap voltage (approximately 3.4 volts) from the supercapacitor energy storage device 148 (also shown as C2) biases the power line and Vbus to logic high when relay pole (XSW3) is open and no device 130 is connected (XSW2 is open). Device connection pulls Vbus and the power line to near ground (XSW2 closes) and voltage at uP_DigitalPort is pulled to logic low. The processor 146 wakes up, turns on relay 144 (XSW3 closes) and 5 volt power appears on Vbus. Zener D3R3V clamps the node at R1 and R2 (uP_DigitalPort) to 3.3 volts.

FIG. 10 illustrates an opto-sensing technique and accordingly shows a circuit 260 including an optical element 262 (also shown as U1). With relay pole open (XSW3) and no device 130 connected (XSW2 open) no current from the supercap 148 flows through the LED in U1. The transistor in U1 is off and the node uP_DigitalPort is at logic high. When a device 130 is connected (XSW2 closes) current flows which in turn causes the LED to send light energy to the base of the transistor in U1. The transistor turns on and subsequently uP_DigitalPort is pulled to logic low. The processor 146 wakes up, turns on relay 144 (XSW3 closes) and 5 volt power appears on Vbus. The LED in U1 is now reverse biased and prevents the 5 volts on Vbus from affecting the supercap voltage and microprocessor port.

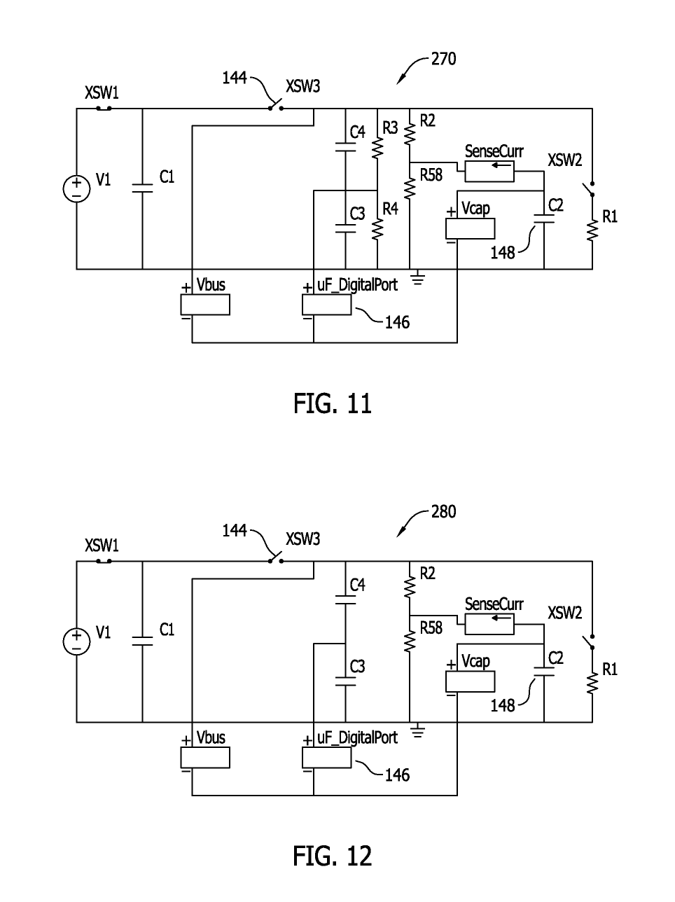

FIG. 11 illustrates the capacitive sensing technique in a circuit 270 including series capacitors C4 and C3 connected to the controller input port. With relay pole open (XSW3) and no device 130 connected (XSW2 open) the supercap voltage biases Vbus to a logic high value, which in turn charges the series capacitor arrangement C4 and C3. The node common to the two capacitors is connected to uP_DigitalPort. On this node is impressed half the bias voltage on Vbus when C3 and C4 are equal.

When a device 130 is connected (XSW2 closes), the series stack of capacitors C4 and C3 discharges abruptly to a low value, and the abrupt drop in voltage on uP_DigitalPort wakes up the processor 146, which in turn closes the relay 144 (closes XSW3). The subsequent 5 volts that appears on Vbus is divided down at the common node of R2 and R58 in order that not more than 3.4 volts is impressed on the supercap 148.

The resistors R3 and R4 are chosen to supply balancing currents to or from the common node of C4 and C3 when the properties of these two capacitors are not matched adequately, or when the leakage current on uP_DigitalPort is high enough to otherwise pull down the node voltage. C4 can generally be larger than C3, which would raise the common node voltage without affecting the proper and intended operation of the circuit 270. As a result balancing resistors R3 and R4 are needed mainly when leakage current in the capacitors and/or digital port are so large that they will drive the node over time to ground potential. Therefore, the balancing resistors may often be dispensed with but may be necessary in some cases.

FIG. 12 illustrates an alternative implementation of a capacitive sensing technique in a circuit 280 that is similar to circuit 270 but without the balancing resistors R3 and R4. C4 can be larger than C3 and do not have to be equal in the circuit 280, which otherwise operates as described above.

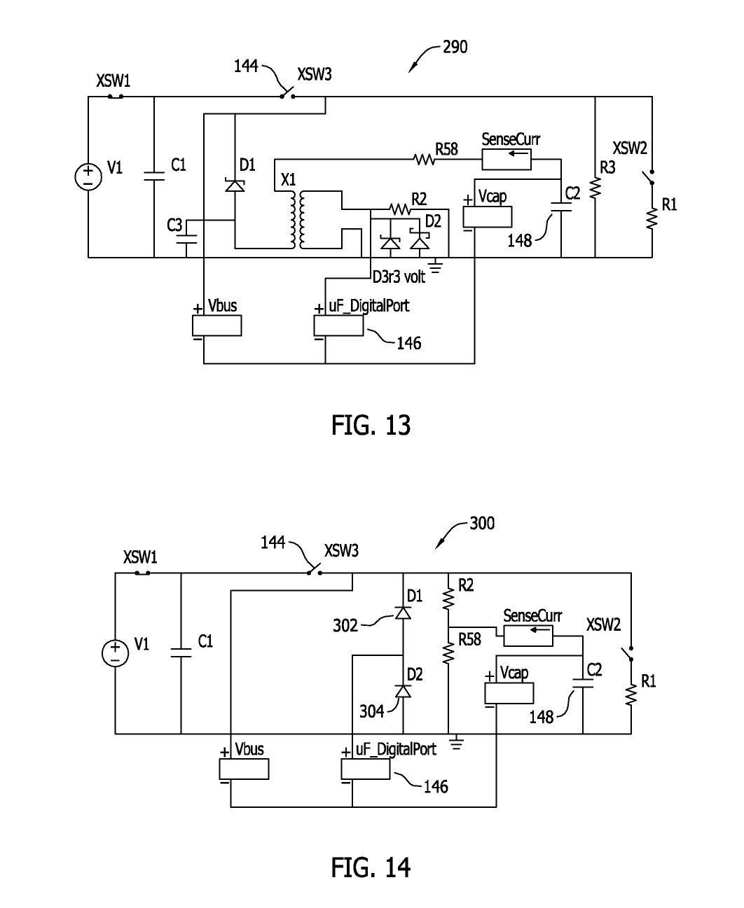

FIG. 13 illustrates the transformer sensing technique in a circuit 290 including a transformer 292 connected to the controller input port. With relay pole open (XSW3) and no device 130 connected (XSW2 open) no current from the supercap 148 flows through the primary of transformer X1 and the diode D1. The uP_DigitalPort node is attached to the transformer secondary, which is loaded with resistor R2, and will reside at ground under the condition that no current flows in the primary.

FIG. 13 illustrates the transformer sensing technique in a circuit 290 including a transformer 292 connected to the controller input port. When a device 130 is attached (XSW2 closes) and the current begins to rapidly rise in the transformer primary to a steady-state value. By transformer action a voltage will abruptly appear on node uP_DigitalPort and rapidly decay. The magnitude of this voltage is determined by properties of the transformer and the value of the load resistor R2. Diode D3r3 volt is a 3.3 volt zener diode that limits the magnitude of this voltage to an acceptable value. This voltage pulse will wake up the processor 146, which turns on the relay 144 (XSW3 closes), and 5 volt power appears on Vbus. Diode D1 prevents the 5 volts on Vbus from affecting the supercap voltage and microprocessor port. Diode D2 clamps negative pulses to ground that will occur when current stops flowing in the primary when the device is disconnected and the relay pole opens. Capacitor C3 helps stabilize the circuit against oscillations.

FIG. 14 illustrates the diode sensing technique in a circuit 300 including diodes 302, 304 connected to the controller input port. Diode sensing is similar in operation and behavior to capacitor sensing as described above. Essentially, the diodes 302, 304 are back-biased so that only a very small reverse leakage current can flow while their junction capacitance is charged by the supercap voltage. When a device 130 is attached the circuit 300 behaves like that which is described for capacitive sensing. Since diode reverse bias leakage currents can be high, balancing resistors (not shown) may be required.

Using the techniques illustrated in FIGS. 2-8 and 9-14 a variety of different power strip devices 100 using various combinations of sensing techniques for the various output ports provided in the device 100 to determine whether or not an electronic device 130 is connected or not to one or more of the output ports provided. The control circuits and sensing techniques may be the same or different from one another to monitor the various output ports provided.

It should be noted that while the techniques illustrated in FIGS. 2-8 and 9-14 are described in the context of the multi-port power strip device 100, they could likewise be provided in stand-alone charger appliances that plug-in to a standardized electrical outlet such as the AC output port similar to the AC output port 110 shown in FIG. 1.

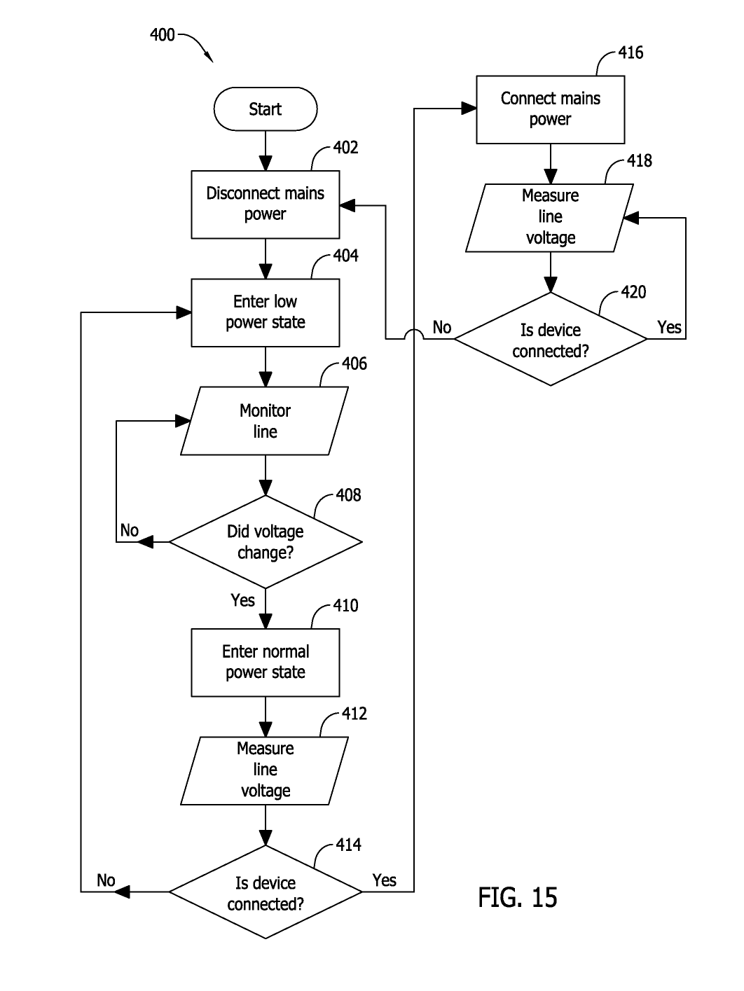

FIG. 15 illustrates an exemplary flow chart of an algorithm 400 for processes performed by and implemented with any of the circuits and the processor-based controls described above for the power strip device 100, including but not necessarily limited to the controller 146 in the exemplary circuits described above. The processor-based controls, via the exemplary algorithm may respond to actual connection of the charger to the portable electronic device, and disconnection of the charger from the portable electronic device via detected changes in voltages on one or more of the power line and the signal lines as described above to determine whether the charging cable is connected or disconnected from the electrical device 130. In embodiments where more than one controller is provided, each controller may operate to perform similar method as shown.

As shown in FIG. 15, the algorithm 400 begins with the mains power disconnected from of all the output ports in the device 100 via the switch(es) in the control circuit(s) provided in the smart power strip device 100 as shown at step 402. The controller enters its low power sleep state at step 404, but in the sleep state is configured to monitor the power line or at least one signal line as shown as step 406. In certain contemplate embodiments the controller may monitor both the power line and one or more signal lines associated with each of the output ports in the device 100.

As explained above, a voltage change on one of the monitored power or signal lines, as sensed by any of the techniques and circuits described above, will cause the controller to wake up from the low power sleep state. Accordingly, as shown at step 406, if the voltage on the monitored power or signal lines does not change, the controller remains in the sleep state but continues to monitor the power line or signal line.

When a voltage change is detected at step 408, (e.g., the monitored voltage is pulled to ground potential or otherwise changes as sensed via any of the techniques described above) the controller wakes up and enters its normal operating state at full power. The controller may optionally measure the voltage on the power or signal line as shown at step 412 and may determine if the measured voltage indicates whether the electronic device is connected or disconnected as shown at step 414. Any of the techniques described above may be used to make this determination of whether the charge is in a connected state with a portable electronic device, or whether the charger is in the no-load state or unconnected to any portable electronic device.

If it is determined at step 414 that the charger is not connected to an electronic device (i.e., the charger is in the no-load state), the controller returns to enter the low power sleep state as shown at step 404.

If it is determined at step 414 that the charger is connected to an electronic device (i.e., one of the output ports in the device 100 is connected to an electronic device for charging), the controller connects the mains power as shown at step 416 so that charging power can be supplied through the appropriate output port and accordingly supply power to the connected electronic device. The controller then, as shown as at step 418 continues to monitor the voltage of the power line and signal line(s) using any of the techniques described above. When the voltage changes again on the monitored line(s), the controller may determine the charger state using the techniques described above.

If at step 420 it is determined that the charger has been disconnected from the electronic device, the controller returns to disconnect the mains power supply as shown at step 402.

If at step 420 it is determined that the charger remains connected to the electronic device, the controller returns to step 418 and continues to monitor the voltage of the signal line(s).

Using the algorithm 400, the controller remains in a low power state until a portable device is connected to one of the output ports provided in the smart power strip device 100, and thereafter remains in its normal, full power operating state until the portable electronic device is disconnected. That is, the controller remains electrically active at all times when the mains power supply is connected and draws power from the energy storage device provided in the charger to continuously monitor the signal line(s). The energy storage device is recharged by the converter circuitry as in the charger as it operates, however, and hence the energy storage device in the charger will be fully charged when the controller later enters its low power sleep state.

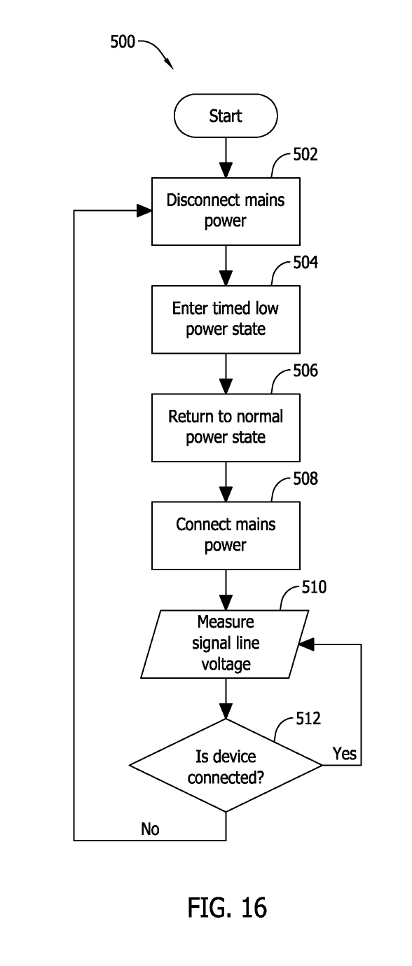

FIG. 16 is an exemplary flow chart of an alternative algorithm 500 for processes performed by and implemented with the processor-based controls described above, including but not necessarily limited to the controller 146 in the exemplary circuits described above. The algorithm 500 may be implemented using any of the control circuitry and sensing techniques described above.

Like the algorithm 400 (FIG. 15) the algorithm 500 shown in FIG. 16 begins with the mains power disconnected via the switch(es) in the power strip device 100 as shown at step 502. The controller enters its low power sleep state at step 504.

After a predetermined time period expires, the controller wakes up and enters its normal operating state at full power as shown at step 506. The controller then connects the mains power via the switch as shown at step 508 and measures the voltage on the signal line(s) as shown at step 510.

The controller may then determine at step 512 if the measured voltage indicates whether the electronic device is connected or disconnected to or from any of the output ports provided in the smart power strip device 100. Any of the techniques described above may be used to make this determination of whether the charge is in a connected state with a portable electronic device, or whether the charger is in the no-load state or unconnected to any portable electronic device.

If it is determined at step 512 that the charger is not connected to an electronic device (i.e., the charger is in the no-load state), the controller returns to disconnect the mains power supply at step 502 and enter the low power sleep state as shown at step 504.

If it is determined at step 512 that the charger is connected to an electronic device (i.e., the charger is connected to an electronic device for charging), the controller continues to measure the voltage of the signal line(s) at step 510 using any of the techniques described above.

Comparing the algorithms 400 and 500, it is seen that the algorithm 500 does not rely on a monitored voltage to wake the controller. Rather, the controller periodically wakes up to measure the voltage on the monitored signal lines. Also, the algorithm 500 does not utilize voltage of the energy storage device in the charger to monitor the voltage, but rather connects the mains power to make the voltage determinations. As a result, the algorithm 500 is a bit simpler to implement, but would consume more power than the algorithm 400 in actual use.

Having now described the algorithms 400 and 500 it is believed that those in the art may program the controller 146 or otherwise configure it to implement the processes and features shown and described in relation to FIGS. 1-14. It is recognized, however, that not all of the process steps as shown and described in FIGS. 15 and 16 are necessary to accomplish at least some of the benefits described. It is further recognized that the sequence of the steps as described are not necessarily limited to the particular order set forth, and that some of the functionality described can be achieved with other sequences of steps. Additional steps beyond those specifically described may also be implemented in combination with the steps described.

The benefits and advantages of the inventive concepts are now believe to have been amply illustrated in relation to the exemplary embodiments disclosed.

An embodiment of a multi-port charger appliance device for recharging batteries of portable electronic devices has been disclosed. The multi-port charger appliance device includes: a body; a plurality of power output ports provided on the body; converter circuitry associated with each of the plurality of power output ports, the converter circuitry configured to receive input electrical power supplied by a mains power supply and adapt the input electrical power to a direct current (DC) output power suitable to recharge a battery of one of the portable electronic devices when connected to one of the power output ports; at least one switch operable to connect the converter circuitry and the mains power supply so that the converter circuitry receives the input power, and the switch operable to disconnect the converter circuitry and the mains power supply so that the converter circuitry is isolated from the mains power supply; and control circuitry. The control circuitry is configured to: detect whether one of the portable electronic devices is connected or unconnected to each of the plurality of power output ports; when a connection of one of the portable electronic devices to a respective one of the plurality of power output ports is detected, automatically operate the at least one switch to connect the converter circuitry to the mains power supply and provide the DC output power to the respective one of the plurality of power output ports; and when a disconnection of one of the portable electrical devices from a respective one of the plurality of power output ports is detected, automatically operate the at least one switch to disconnect the converter circuitry from the mains power supply.

Optionally, the converter circuitry may include: a first converter circuit configured to output a first DC output power to a first one of the plurality of power output ports when connected to the first one of the plurality of power output ports and when the first converter circuit is connected to the mains power supply, the first output power meeting a recharging requirement of a first portable electronic device; and a second converter circuit configured to output a second DC output power to a second one of the plurality of power output ports when connected to the second one of the plurality of power output ports and when the second converter circuit is connected to the mains powers supply, the second power output meeting a recharging requirement of a second portable electronic device; wherein the first DC output power and the second DC output power are different from one another. The control circuitry may be configured to, depending on whether a connection or disconnection of a portable electronic device is detected for each of the first and second ones of the plurality of power output ports, independently provide the first and second DC output power to the respective first and second ones of the plurality of power output ports on demand. The first converter circuit may be configured to output a 5 volt, DC output power to the first one of the plurality of power output ports. At least one of the first and second ones of the plurality of power output ports may be configured as a Universal Serial Bus (USB) port. One of the first and second ones of the plurality of power output ports may supply a 1 ampere, 5 volt power supply to one of the first and second portable electronic devices. One of first and second ones of the plurality of power output ports may supply a 2.4 ampere, 5 volt power supply to one of the first and second portable electronic devices. The second converter circuit may be configured to output a 19 volt, DC output power to a second one of the plurality of power output ports.

The multi-port charger appliance device of claim 1 may also optionally include at least one additional power output port, wherein the at least one additional power output port is configured as a standard alternating current (AC) plug.

Optionally, the multi-port charger appliance device may include converter circuitry including: a first converter circuit supplying a first DC output power to a first one of the plurality of power output ports; a second converter circuit supplying a second DC output power to a second one of the plurality of power output ports, wherein the second DC output power is different from the first DC output power; and a third converter circuit supplying a third DC output power to a third one of the plurality of power output ports, wherein the third DC output power is different from the second DC output power. At least one of the first, second and third DC output power may be a 5 volt, DC output power; and at least another of the first, second and third DC output power may be a 19 volt output power. The first output power may be a 1 ampere, 5 volt, DC output power and the second output power may be a 2.4 ampere, 5 volt, DC output power.

Optionally, the multi-port charger appliance device may include converter circuitry having a single power converter supplying output power to the plurality of power output ports. As another option, the plurality of power output ports may include at least three power output ports.

Each of the plurality of power output ports may be configured to connect with a portable electronic device via a cable and connector. The connector may include a power bus and a ground return line. The control circuitry may be configured to sense an operating state of the power bus in order to determine whether a portable electronic device is connected or disconnected to at least one of the plurality of power output ports. The at least one switch may include a first switch element operable to connect and disconnect the mains power supply and a power input of the converter circuitry, and a second switch element operable to connect and disconnect an output of the converter circuitry to the at least one of the plurality of power output ports. The control circuitry may be configured to operate the first and second switch elements in response to a detected voltage change on the power bus. The first and second switch elements may correspond to a first pole and a second pole of a relay switch. At least one of the first and second switch elements may also be a semiconductor switch. The semiconductor switch may be one of a MOSFET and a Schottkey diode.

Optionally, the cable may further include at least one signal line, and the control circuitry may be configured to monitor a voltage of the at least one signal line to determine whether the cable is connected or disconnected to the portable electronic device. The at least one signal line may include a pair of signal lines that are shorted together.

The control circuitry may include an energy storage element and a processor-based device, and the processor-based device may be configured to monitor the power bus and operate the at least one switch in response to a voltage change on the power bus. The energy storage element may be operable to power the processor-based device when the converter circuitry is disconnected from the mains power supply. The processor-based device may be configured to monitor the voltage of the power bus while the converter circuitry is disconnected from the mains power supply. The processor-based device may be operable in a low power sleep mode, and may be configured to: wake up when a change in voltage of the power bus is detected, and operate the switch to connect or disconnect the converter circuitry and the mains power supply based on the detected change in voltage. The processor-based device may be further configured to: wake up when the converter circuitry is disconnected from the mains power supply; measure a voltage associated with the energy storage element; and if the measured voltage is below a predetermined threshold, operate the switch to connect the converter circuitry to the mains power supply for a time sufficient to re-charge the energy storage element to a predetermined voltage. The control circuitry may also include a resistor network at the output of the converter circuitry.

The connector may optionally include a power bus, at least one signal line, and a ground return line; and the processor-based device may be further configured to sense an operating state of either of the power bus or the at least one signal line in order to determine whether a portable device is connected or disconnected. The processor-based device may utilize a first input port and a second input port to determine whether a portable electronic device is connected or disconnected. The control circuitry may be configured to sense a voltage pull-to-ground in order to determine whether a portable electronic device is connected or disconnected. The control circuitry is configured to sense the voltage pull-to-ground via one of resistive sensing, opto-sensing, capacitive sensing, transformer sensing, and diode sensing.

The portable electronic device may be at least one of a cellular phone, a smart phone, a notebook computer, a laptop computer, a tablet computer, a portable DVD player, an audio and video media entertainment device, an electronic reader device, a gaming device, a global positioning system (GPS) device, a digital camera device, and a video recorder device.

The multi-port charger appliance device may also include an interface plug, the interface plug configured to connect to the mains power supply. The interface plug may be configured to connect to a DC power supply of a vehicle via a power outlet provided in the vehicle. The vehicle may be at least one of a passenger vehicle, a commercial vehicle, a construction vehicle, a military vehicle, an off-road vehicle, a marine vehicle, an aircraft, a space vehicle, and a recreational vehicles.

The converter circuitry may be configured to accept input electrical power supplied by an alternating current (AC) mains power supply and adapt the input electrical power to a direct current (DC) output power suitable to recharge the battery of the portable electronic device when the portable electronic device is connected to one of the power output ports.

The converter circuitry may also be configured to accept input electrical power supplied by a direction current (DC) mains power supply and adapt the input electrical power to a DC output power suitable to recharge the battery of the portable electronic device when the portable electronic device is connected to one of the power output ports.

The multi-port charger appliance device may optionally be configured as one of power strip, a wall outlet, a power receptacle of a vehicle, and a furniture outlet. The multi-port charger appliance device may optionally include at least two of the plurality of power output ports configured as Universal Serial Bus (USB) ports. At least one of the plurality of power output ports may provide direct current DC power at a first voltage, and at least another of the plurality of power output ports may provide DC power at a second voltage different from the first voltage. The multi-port charger appliance device may also include at least one additional power output port providing alternating current (AC) power. A user-activated power switch may also be provided that is manually operable to connect or disconnect the mains power supply and at least one of the plurality of power output ports that provides alternating current (AC) power.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A multi-port charger appliance device for recharging batteries of portable electronic devices, the multi-port charger appliance device comprising:
a body;
a plurality of power output ports provided on the body;
converter circuitry associated with each of the plurality of power output ports, the converter circuitry configured to receive input electrical power supplied by a mains power supply and adapt the input electrical power to a direct current (DC) output power suitable to recharge a battery of one of the portable electronic devices when connected to one of the power output ports;
at least one switch operable to connect the converter circuitry and the mains power supply so that the converter circuitry receives the input power, and the switch operable to disconnect the converter circuitry and the mains power supply so that the converter circuitry is isolated from the mains power supply; and
control circuitry configured to:
detect whether one of the portable electronic devices is connected or unconnected to each of the plurality of power output ports;
when a connection of one of the portable electronic devices to a respective one of the plurality of power output ports is detected, automatically operate the at least one switch to connect the converter circuitry to the mains power supply and provide the DC output power to the respective one of the plurality of power output ports; and
when a disconnection of one of the portable electrical devices from a respective one of the plurality of power output ports is detected, automatically operate the at least one switch to disconnect the converter circuitry from the mains power supply.

2. The multi-port charger appliance device of claim 1, wherein the converter circuitry comprises:
a first converter circuit configured to output a first DC output power to a first one of the plurality of power output ports when connected to the first one of the plurality of power output ports and when the first converter circuit is connected to the mains power supply, the first output power meeting a recharging requirement of a first portable electronic device; and
a second converter circuit configured to output a second DC output power to a second one of the plurality of power output ports when connected to the second one of the plurality of power output ports and when the second converter circuit is connected to the mains powers supply, the second power output meeting a recharging requirement of a second portable electronic device;
wherein the first DC output power and the second DC output power are different from one another.

3. The multi-port charger appliance device of claim 2, wherein the control circuitry is configured to, depending on whether a connection or disconnection of a portable electronic device is detected for each of the first and second ones of the plurality of power output ports, independently provide the first and second DC output power to the respective first and second ones of the plurality of power output ports on demand.

4. The multi-port charger appliance device of claim 3, wherein the first converter circuit is configured to output a 5 volt, DC output power to the first one of the plurality of power output ports.

5. The multi-port charger appliance device of claim 4, wherein at least one of the first and second ones of the plurality of power output ports is configured as a Universal Serial Bus (USB) port.

6. The multi-port charger appliance device of claim 5, wherein one of the first and second ones of the plurality of power output ports supplies a 1 ampere, 5 volt power supply to one of the first and second portable electronic devices.

7. The multi-port charger appliance device of claim 5, wherein one of the first and second ones of the plurality of power output ports supplies a 2.4 ampere, 5 volt power supply to one of the first and second portable electronic devices.

8. The multi-port charger appliance device of claim 3, wherein the second converter circuit is configured to output a 19 volt, DC output power to a second one of the plurality of power output ports.

9. The multi-port charger appliance device of claim 1, further comprising at least one additional power output port, wherein the at least one additional power output port is configured as a standard alternating current (AC) plug.

10. The multi-port charger appliance device of claim 1, wherein the converter circuitry comprises:
a first converter circuit supplying a first DC output power to a first one of the plurality of power output ports;
a second converter circuit supplying a second DC output power to a second one of the plurality of power output ports, wherein the second DC output power is different from the first DC output power; and
a third converter circuit supplying a third DC output power to a third one of the plurality of power output ports, wherein the third DC output power is different from the second DC output power.

11. The multi-port charger appliance device of claim 10,
wherein at least one of the first, second and third DC output power is a 5 volt, DC output power; and
wherein at least another of the first, second and third DC output power is a 19 volt output power.

12. The multi-port charger appliance device of claim 10,
wherein the first output power is a 1 ampere, 5 volt, DC output power; and
wherein the second output power is a 2.4 ampere, 5 volt, DC output power.

13. The multi-port charger appliance device of claim 1, wherein the converter circuitry includes a single power converter supplying output power to the plurality of power output ports.

14. The multi-port charger appliance device of claim 1, wherein the plurality of power output ports includes at least three power output ports.

15. The multi-port charger appliance device of claim 1, wherein each of the plurality of power output ports is configured to connect with a portable electronic device via a cable and connector.

16. The multi-port charger appliance device of claim 15, wherein the connector includes a power bus and a ground return line.

17. The multi-port charger appliance device of claim 16, wherein the control circuitry is configured to sense an operating state of the power bus in order to determine whether a portable electronic device is connected or disconnected to at least one of the plurality of power output ports.

18. The multi-port charger appliance device of claim 17, wherein the at least one switch comprises a first switch element operable to connect and disconnect the mains power supply and a power input of the converter circuitry, and a second switch element operable to connect and disconnect an output of the converter circuitry to the at least one of the plurality of power output ports.

19. The multi-port charger appliance device of claim 18, wherein the control circuitry is configured to operate the first and second switch elements in response to a detected voltage change on the power bus.

20. The multi-port charger appliance device of claim 18, wherein the first and second switch elements correspond to a first pole and a second pole of a relay switch.

21. The multi-port charger appliance device of claim 18, wherein at least one of the first and second switch elements comprises a semiconductor switch.

22. The multi-port charger appliance device of claim 21, wherein the semiconductor switch is one of a MOSFET and a Schottkey diode.

23. The multi-port charger appliance device of claim 16, wherein the cable further includes at least one signal line, and wherein the control circuitry is configured to monitor a voltage of the at least one signal line to determine whether the cable is connected or disconnected to the portable electronic device.

24. The multi-port charger appliance device of claim 23, wherein the at least one signal line includes a pair of signal lines that are shorted together.

25. The multi-port charger appliance device of claim 17, wherein the control circuitry includes an energy storage element and a processor-based device, the processor-based device configured to monitor the power bus and operate the at least one switch in response to a voltage change on the power bus.

26. The multi-port charger appliance device of claim 25, wherein the energy storage element is operable to power the processor-based device when the converter circuitry is disconnected from the mains power supply.

27. The multi-port charger appliance device of claim 25, wherein the processor-based device is configured to monitor the voltage of the power bus while the converter circuitry is disconnected from the mains power supply.

28. The multi-port charger appliance device of claim 27, wherein the processor-based device is operable in a low power sleep mode, and is configured to:
wake up when a change in voltage of the power bus is detected, and
operate the switch to connect or disconnect the converter circuitry and the mains power supply based on the detected change in voltage.

29. The multi-port charger appliance device of claim 26, wherein the processor-based device is operable in a low power sleep mode, and wherein the processor-based device is further configured to:
wake up when the converter circuitry is disconnected from the mains power supply;
measure a voltage associated with the energy storage element; and
if the measured voltage is below a predetermined threshold, operate the switch to connect the converter circuitry to the mains power supply for a time sufficient to re-charge the energy storage element to a predetermined voltage.

30. The multi-port charger appliance device of claim 17, wherein the control circuitry includes a resistor network at the output of the converter circuitry.

31. The multi-port charger appliance device of claim 15,
wherein the connector includes a power bus, at least one signal line, and a ground return line; and
wherein the processor-based device is further configured to sense an operating state of either of the power bus or the at least one signal line in order to determine whether a portable device is connected or disconnected.

32. The multi-port charger appliance device of claim 31, wherein the processor-based device utilizes a first input port and a second input port to determine whether a portable electronic device is connected or disconnected.

33. The multi-port charger appliance device of claim 15, wherein the control circuitry is configured to sense the voltage pull-to-ground in order to determine whether a portable electronic device is connected or disconnected.

34. The multi-port charger appliance device of claim 33, wherein the control circuitry is configured to sense a voltage pull-to-ground via one of resistive sensing, opto-sensing, capacitive sensing, transformer sensing, and diode sensing.

35. The multi-port charger appliance device of claim 1, wherein the portable electronic device comprises at least one of a cellular phone, a smart phone, a notebook computer, a laptop computer, a tablet computer, a portable DVD player, an audio and video media entertainment device, an electronic reader device, a gaming device, a global positioning system (GPS) device, a digital camera device, and a video recorder device.

36. The multi-port charger appliance device of claim 1, further comprising an interface plug, the interface plug configured to connect to the mains power supply.

37. The energy management control of claim 36, wherein the interface plug is configured to connect to a DC power supply of a vehicle via a power outlet provided in the vehicle.

38. The energy management control of claim 37, wherein the vehicle is at least one of a passenger vehicle, a commercial vehicle, a construction vehicle, a military vehicle, an off-road vehicle, a marine vehicle, an aircraft, a space vehicle, and a recreational vehicles.

39. The multi-port charger appliance device of claim 1, wherein the converter circuitry is configured to accept input electrical power supplied by an alternating current (AC) mains power supply and adapt the input electrical power to a direct current (DC) output power suitable to recharge the battery of the portable electronic device when the portable electronic device is connected to one of the power output ports.

40. The multi-port charger appliance device of claim 1, wherein the converter circuitry is configured to accept input electrical power supplied by a direction current (DC) mains power supply and adapt the input electrical power to a DC output power suitable to recharge the battery of the portable electronic device when the portable electronic device is connected to one of the power output ports.

41. The multi-port charger appliance device of claim 1 wherein the device is configured as one of power strip, a wall outlet, a power receptacle of a vehicle, and a furniture outlet.

42. The multi-port charger appliance device of claim 1, wherein at least two of the plurality of power output ports are configured as Universal Serial Bus (USB) ports.

43. The multi-port charger appliance device of claim 1, wherein at least one of the plurality of power output ports provides direct current DC power at a first voltage, and at least another of the plurality of power output ports provides DC power at a second voltage different from the first voltage.

44. The multi-port charger appliance device of claim 43, further comprising at least one additional power output port providing alternating current (AC) power.

45. The multi-port charger appliance device of claim 44, further comprising a user-activated power switch that is manually operable to connect or disconnect the mains power supply and at least one of the plurality of power output ports that provides alternating current (AC) power.
